(19) United States
(12) Patent Application Publication
(10) Pub. No.: US 2014/0260842 A1
(43) Pub. Date: Sep. 18, 2014

(54) Fishing Line Tool System and Method

(71) Applicant: Donald E. Bell, Fritch, TX (US)

(72) Inventor: Donald E. Bell, Fritch, TX (US)

(21) Appl. No.: 13/798,073

(22) Filed: Mar. 12, 2013

(51) Int. Cl. A01K 97/00

(52) U.S. Cl. CPC A01K 97/00
USPC 83/13; 30/280

(57) ABSTRACT

A first fishing line tool comprising: a body portion having a first end and a second end; a sleeve wrapping around a portion of said body portion; a blade attaching to a portion of said body portion; a notch in said first end of said body portion; a strap attached to said second end of said body portion; and an aperture in said second end of said body portion. Said blade is attached to said body portion within said notch. Said sleeve selectively covers a portion of said notch with said blade. Said strap attaches to said body portion by passing a portion of said strap through said aperture. Said body portion comprises wood. Said sleeve comprises rubber.

### BACKGROUND

This disclosure relates generally to a system and method for cutting and tugging a fishing line. An example of a fishing line cutter can be found in U.S. Pat. No. 6,851,215. However, none of the known inventions and patents, taken either singularly or in combination, is seen to describe the instant disclosure as claimed. Accordingly, an improved system and method for cutting and tugging a fishing line would be advantageous.

### SUMMARY

A first fishing line tool, a second fishing line tool and a method of using a fishing line tool are disclosed.

Said first fishing line tool comprises: a body portion having a first end and a second end; a sleeve wrapping around a portion of said body portion; a blade attaching to a portion of said body portion; a notch in said first end of said body portion; a strap attached to said second end of said body portion; and an aperture in said second end of said body portion. Said blade is attached to said body portion within said notch. Said sleeve selectively covers a portion of said notch with said blade. Said strap attaches to said body portion by passing a portion of said strap through said aperture. Said body portion comprises wood. Said sleeve comprises rubber.

Said second fishing line tool comprises: a body portion having a first end and a second end; a sleeve wrapping around a portion of said body portion; and a blade attaching to a portion of said body portion.

Said method of using a fishing line tool comprising: wrapping a line around a sleeve of a fishing line tool; pulling a body portion of said fishing line tool; and gripping a portion of said line with said sleeve by deforming a portion of said sleeve while pulling said body portion of said fishing line tool.

### BRIEF DESCRIPTION OF THE DRAWINGS

FIGS. 1A, 1B and 1C illustrate a perspective overview, an elevated front view and an elevated side view of a fishing line tool.

FIGS. 2A, 2B and 2C illustrate a perspective overview, an elevated front view and an elevated side view of said fishing line tool with a sleeve portion of said fishing line tool being removed.

FIG. 3 illustrates a perspective overview of said fishing line tool.

FIG. 4 illustrates a perspective overview of said fishing line tool, used for tugging a line, and said line being pulled.

FIG. 5 illustrates a perspective overview of said fishing line tool being used for cutting said line.

### DETAILED DESCRIPTION

Described herein is a system and method used for cutting and tugging a fishing line. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

FIGS. 1A, 1B and 1C illustrate a perspective overview, an elevated front view, and an elevated side view of a fishing line tool 100. In one embodiment, said fishing line tool 100 can comprise a body portion 102, a strap 104, a sleeve 106, a notch 108 and a blade 110. In one embodiment, said body portion 102 can be cylindrical in shape having a first end 112 and a second end 114. In one embodiment, said first end 112 and said second end 114 can be rounded. In one embodiment, said body portion 102 can comprise an aperture 116 at said second end 114. In one embodiment, said aperture 116 comprises a hole through a portion of said body portion 102. In one embodiment, said strap 104 can be attached to said body portion 102 through said aperture 116 by passing a portion of said strap 104 through said aperture 116. In one embodiment, said sleeve 106 can slide up and down to expose portions of said notch 108. In one embodiment, said strap 104 can slide around a wrist of a user of said fishing line tool 100. In one embodiment, said sleeve 106 can comprise an internal diameter substantially equal to an external diameter of said body portion 102. In one embodiment, said fishing line tool 100 and/or said body portion 102 can be comprised of buoyant material (such as wood or a plastic) and can float if dropped into a body of water. In one embodiment, said body portion 102 can comprise a plastic with a sealed cavity therein so that said fishing line tool 100 can be buoyant. In one embodiment, said strap 104 can be detachable from said fishing line tool 100; for example, said strap 104 can comprise a clasp similar to those found on necklaces.

FIGS. 2A, 2B and 2C illustrate a perspective overview, an elevated front view, and an elevated side view of said fishing line tool 100 with said sleeve 106 removed. In one embodiment, said notch 108 is considered to be “C” or “U” shaped, and is located toward said first end 112 of said body portion 102.

FIG. 3 illustrates a perspective overview of said fishing line tool 100. In one embodiment, said blade 110 can be located in a back portion 300 of said notch 108 and toward said first end 112 of said body portion 102. In one embodiment, said blade 110 can be triangular in shape.

FIG. 4 illustrates a perspective overview of a line 402 wrapped around said sleeve 106 of said fishing line tool 100. In one embodiment, said fishing line tool 100 can be used for tugging said line 402. In one embodiment, said fishing line tool 100 can be used for pulling said line 402 out of the water by wrapping said line 402 around said fishing line tool 100 at said sleeve 106, and tugging in a suitable direction. In one embodiment, said sleeve 106 can comprise of a durable material such as rubber or vinyl; wherein, said line 402 can dig into said sleeve 106 when tugged upon.

FIG. 5 illustrates a perspective overview of said fishing line tool 100 being used for cutting said line 402. In one embodiment, said fishing line tool 100 can cut said line 402 by: exposing a portion of said notch 108 by sliding said sleeve 106 off of said notch 108 by moving said sleeve 106 towards said second end 114 and away from said first end 112; wrapping a portion of said line 402 across said blade 110; and cutting said line 402 with said blade 110.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A fishing line tool comprising:
a body portion having a first end and a second end;
a sleeve wrapping around a portion of said body portion;
a blade attached in said first end of said body portion;
a notch in said first end of said body portion;
said blade is attached to said body portion within said notch;
said sleeve selectively covers a portion of said notch with said blade;
a strap attached to said second end of said body portion;
an aperture in said second end of said body portion;
said strap attaches to said body portion by passing a portion of said strap through said aperture;
said body portion comprises wood; and
said sleeve comprises vinyl.

2. A fishing line tool comprising:
a body portion having a first end and a second end;
a sleeve wrapping around a portion of said body portion; and
a blade attached in said first end of said body portion.

3. The fishing line tool of claim 2 further comprising
a notch in said first end of said body portion; and wherein,
said blade is attached to said body portion within said notch, and
said sleeve selectively covers a portion of said notch with said blade.

4. The fishing line tool of claim 2 further comprising
a strap attached to said second end of said body portion.

5. The fishing line tool of claim 4 further comprising
an aperture in said second end of said body portion; and wherein,
said strap attaches to said body portion by passing a portion of said strap through said aperture.

6. The fishing line tool of claim 2 wherein said body portion is a buoyant material.

7. The fishing line tool of claim 6 further comprising said body portion comprises wood.

8. The fishing line tool of claim 6 further comprising said body portion comprises plastic.

9. The fishing line tool of claim 2 wherein said sleeve comprises a durable material.

10. The fishing line tool of claim 2 wherein said sleeve comprises rubber.

11. The fishing line tool of claim 2 wherein said sleeve comprises vinyl.

12. A method of using a fishing line tool comprising:
wrapping a line around a sleeve of a fishing line tool;
pulling a body portion of said fishing line tool; and
gripping a portion of said line with said sleeve by deforming a portion of said sleeve while pulling said body portion of said fishing line tool.

13. The method of claim 12 further comprising:
exposing a blade in a notch in a first end of said body portion; wherein,
sliding said sleeve to expose said blade in said notch;
wrapping a portion of said line across said blade; and
pulling said body portion so that said line is cut by said blade.
